(19) United States
(12) Patent Application Publication
(10) Pub. No.: US 2026/0310227 A1
(43) Pub. Date: Oct. 8, 2026

(54) METHOD FOR PICKING UP OR DROPPING OFF PASSENGERS INDOOR BY AN AUTONOMOUS VEHICLE

(71) Applicant: TPK Advanced Solutions Inc., Xiamen (CN)

(72) Inventors: An-Lun HAN, Taipei City (TW); Shih-Hao Yu, Taipei City (TW)

(21) Appl. No.: 19/452,533

(22) Filed: Jan. 19, 2026

(30) Foreign Application Priority Data
Feb. 5, 2025 (CN) 202510129423.1

(51) Int. Cl. G05D 1/656; G05D 1/246; G05D 1/248; G05D 1/249; G05D 103/00; G05D 105/22; G05D 107/60; G05D 109/10

(52) U.S. Cl. CPC G05D 1/656; G05D 1/246; G05D 1/248; G05D 1/249; G05D 2103/00; G05D 2105/22; G05D 2107/60; G05D 2109/10

(57) ABSTRACT

A method for picking up or dropping off passenger indoor in an autonomous vehicle is provided, including receiving a request to get passenger on or off indoor by a processor; confirming an entrance position through a map system and a first positioning system by the processor; confirming the entrance position and an entrance traffic control status by a sensor to output an output signal when the autonomous vehicle arrives near the entrance position; entering from the entrance position into the indoor space with the autonomous vehicle when the processor determines that the entrance traffic control status is an enterable state; switching to an indoor operation mode by the processor according to a switching signal when the autonomous vehicle enters the indoor space; and establishing a departure path in the indoor operation mode by the processor according to a completion signal of the passenger getting on or off the vehicle.

### CROSS-REFERENCE TO RELATED APPLICATION

This application claims priority to China Patent Application 202510129423.1, filed Feb. 5, 2025, which is incorporated herein by reference.

### FIELD OF DISCLOSURE

The present disclosure relates to a method, especially a method for picking up or dropping off passengers indoors by an autonomous vehicle.

### DESCRIPTION OF RELATED ART

In current technology, autonomous vehicles, or so-called self-driving vehicles, are progressing as emerging technology advances. Autonomous vehicles bring more convenience to daily life. Autonomous vehicles can help to transport passengers or goods from one location to another. With traditional technology, autonomous vehicles are still paired with “remote operators” to examine images of the surrounding environment and information on real-time road conditions to provide assistance in commanding the vehicle in navigating through more complex environments. However, the time spent on remote operations and decision-making by back-and-forth data transfers may not be prompt enough to allow the vehicle to respond in time to the situation on site, resulting in inconvenience to others. In addition, the requirement of remote operators shows that such autonomous vehicles have not achieved the capability of true self-driving.

Therefore, there is a need to improve the traditional technology.

### SUMMARY

One embodiment of the present disclosure provides a method for picking up or dropping off passengers indoor by an autonomous vehicle, wherein the method comprises: (1) receiving, by at least one processor provided on the autonomous vehicle, a request for a passenger to be picked up or dropped off at an indoor space of a building; (2) confirming, by the at least one processor, using a map system and a first positioning system, an entrance position of the indoor space of the building; (3) when the autonomous vehicle arrives a location near the entrance position, confirming the entrance position by the at least one processor using at least one sensor, wherein the at least one sensor detects an entrance traffic control status of the entrance position to output an output signal; (4) when the at least one processor receives the output signal and determines that the entrance traffic control status is an enterable state, controlling, by the at least one processor, the autonomous vehicle to drive into the indoor space from the entrance position; (5) during a course of the autonomous vehicle entering the indoor space of the building, switching, by the at least one processor, to an indoor operation mode according to a switching signal, to control the autonomous vehicle to arrive at a passenger picking up or dropping off position; and (6) establishing, by the at least one processor, a departure path in the indoor operation mode according to a completion signal of the passenger pickup or drop-off from the autonomous vehicle, to control the autonomous vehicle leaving through an exit position of the indoor space of the building.

In several embodiments, the indoor space comprises a basement, an indoor space on a ground floor, an indoor space above the ground floor, or a combination thereof.

In several embodiments, the map system comprises parking lot entrance features, parking lot exit features, maps, driveway markings, stop signs, barrier curbs, sidewalks, or a combination thereof.

In several embodiments, the first positioning system comprises a Global Positioning System (GPS), a BeiDou Navigation Satellite System (BDS), a Globalnaya navigatsionnaya sputnikovaya sistema (GLONASS), a Galileo positioning system, a Quasi-Zenith Satellite System (QZSS), an Indian Regional Navigation Satellite System (IRNSS), or a combination thereof.

In several embodiments, the step (3) comprises confirming the entrance position by at least one surveillance camera through a network with the at least one processor.

In several embodiments, the entrance traffic control status comprises an entrance driveway traffic light control, a single-lane driveway for two-way entrance and exit traffic, hand signals by a security guard, entrance driveway gates, or a combination thereof.

In several embodiments, prior to the step (4), the method further comprises sending, by the at least one processor, a message to the passenger with corresponding information indicating that the autonomous vehicle will arrive at the passenger picking up or dropping off position with delay when the at least one processor receives the output signal and determines that the entrance traffic control status is not the enterable state, or notifying the passenger that an instruction of a changed picking up or dropping off position can be accepted, based on the entrance traffic control status when the at least one processor receives the output signal and determines that the entrance traffic control status is not the enterable state.

In several embodiments, the switching signal comprises signal disappearance of the first positioning system, maps of the map system encountering a switching point, insufficient maps in the map system, or a combination thereof.

In several embodiments, the at least one processor uses an indoor map together with a second positioning system in the indoor operation mode to enable the autonomous vehicle to drive in the indoor space, wherein the indoor map comprises real-time environment maps, pre-constructed environment maps, point cloud planning maps, or a combination thereof.

In several embodiments, the second positioning system comprises at least one of an auxiliary Global Positioning System (AGPS), visual image sensing, magnetic sensing technology, or a radio-frequency identification based (RFID-based) indoor positioning system.

### BRIEF DESCRIPTION OF THE DRAWINGS

The various forms of the present disclosure will be understood most easily through the following descriptions, along with the accompanying figures. Please note that, according to industrial standard operating procedures, dimensions of every feature in the figures may not be depicted according to the actual scale. For clearer explanations, the feature, size, ratio, and configuration may be enlarged or reduced. To allow a better understanding of the aforementioned and other objectives, as well as novel features, advantages, embodiments, and the effect of the present disclosure, figures are provided as follows:

FIG. 1 is a schematic view of the vehicle functions of several embodiments of the present disclosure.

FIG. 2 is a schematic view of the system of several embodiments of the present disclosure.

FIG. 3 is a schematic view of the system of several other embodiments of the present disclosure.

FIG. 4 is a flow chart of the method for picking up or dropping off passengers indoors by an autonomous vehicle of several embodiments of the present disclosure.

FIG. 5 is a flow chart of the method for determining the entrance traffic control status by an autonomous vehicle of several embodiments of the present disclosure.

### DETAILED DESCRIPTION

To better and fully explain the present disclosure, various forms and comprehensive descriptions of embodiments of the present disclosure are provided as follows. However, embodiments of the present disclosure are not limited to this one form only, and the following disclosed embodiments may be combined or substituted under beneficial circumstances. Without further explanation, other embodiments may be included in an embodiment of the present disclosure. In the following descriptions, many specific details will be provided to help readers fully understand the following embodiments. However, under the condition without these specific details, embodiments of the present disclosure can still be implemented.

Furthermore, relative terms in space, for example, “below” and “above,” are applied to describe the relative relation in space of an element or a feature with respect to another element or another feature in the figures. In addition to the direction illustrated in the figures, relative terms in space are intended to describe different directions while the device is being used or in operation. The device can be specified at another position (such as rotated by 90 degrees or other directions), and the relative terms in space used in the present disclosure will describe such a condition correspondingly.

In this document, unless otherwise specified in the text, “a” and “the” may refer to single or multiple subjects. It is further understood that the terms “comprise,” “include,” “have,” and similar terms in this document may refer to the features, regions, integers, steps, operations, components, and/or parts described herein, but what is being described or the additional one or multiple features, regions, integers, steps, operations, components, parts, and/or a combination thereof will not be ruled out.

The following several embodiments and experimental examples are presented to describe the method for picking up passengers indoors by an autonomous vehicle, which shall not be interpreted to limit the scope, applicability, or configuration of the present disclosure in any way. The scope of protection of the present disclosure shall be determined by the appended scope of the claims.

### Embodiments

Although the following descriptions are expressed by a series of operations or steps to explain the method of the present disclosure, the described sequences of the operations and steps shall not be construed as a limitation of the present disclosure. For example, some operations or steps may be performed in different sequences and/or with other steps simultaneously. Furthermore, not all the operations, steps, and/or features in the figures must be executed in order to implement the embodiments of the present disclosure. Additionally, each operation or step described herein may comprise several sub-steps or actions.

To ensure clear descriptions, the features that are known in the field, as well a features and elements that are not essential for understanding the described principles, will be omitted.

With traditional autonomous vehicles still being paired with “remote operators” to examine images of the surrounding environment and information on real-time road conditions, the time spent on remote operations and decision-making by back-and-forth data transfers may not be prompt enough to allow the vehicle to respond in time, leading to inconveniences. For convenience purposes while addressing the demands of passengers getting on or off in basement/indoor environment, for example, for mobility impaired individuals or requests during raining days, the present disclosure provides a method for picking up or dropping off passengers indoor by an autonomous vehicle, allowing the autonomous vehicle to correctly identify the building entrance and the entrance traffic control status, while also having a cross-mode switching operation (for example, different positioning systems) and possessing the capability of an overall transportation operation planning from “receiving the request” to “departing from the exit,” thus accomplishing the pickup or drop-off tasks.

### Systems

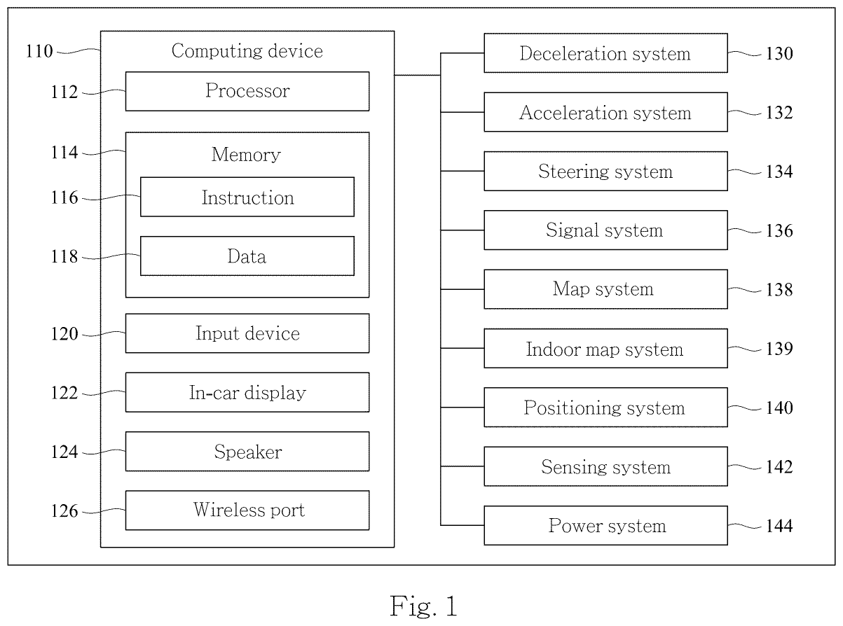

As shown in FIG. 1, according to several embodiments of the present disclosure, a vehicle 100 comprises multiple components. The vehicle 100 comprises one or multiple computing devices 110, for example, one or multiple processors 112 and memory 114. In several embodiments, the vehicle 100 of the present disclosure comprises, but is not limited to, cars, buses, trucks, tour buses, freightliners, and motorcycles.

The memory 114 stores information that can be stored and retrieved by one or multiple processors 112, including an instruction 116 and data 118, which can be executed by the processors 112 or used in other ways. The memory 114 may be any type of memory for storing information that may be stored and retrieved by processors, including computer-readable media or other media storing data readable by the electronic equipment, for example, a hard disk, a memory card, a read-only memory (ROM), a random access memory (RAM), or a combination thereof, and other writable and read-only memory.

The instruction 116 may be any instruction set executed directly or indirectly by the processor 112. For example, the instruction 116 may be a computer equipment code stored on the readable media of a computer equipment. In this regard, the terms “instruction” and “program” may be used interchangeably in the present disclosure. Instructions may be stored in an objective code format for direct processing by the processor 112, or stored in any other computing device language, including scripts to be interpreted on demand or precompiled, or collections of separate source code modules.

The data 118 may be retrieved, stored, or modified by the processor 112 according to instructions 116. The pre-defined scenario may identify a set of scenario requirements, including the type of object, the range of object's position relative to the vehicle, and other factors, for example, whether the autonomous vehicle can be operated around the object, whether the object is operating the turn signal light at the time, relevant traffic control conditions of the location of the object at the time, and whether the object is approaching the stop signs.

One or multiple processors 112 may be any processor of the prior art, for example, the commercially available central processing units (CPU) and graphics processing units (GPU). Or, the one or multiple processors 112 may be a specific type of equipment, for example, an application-specific integrated circuit (ASIC) or other hardware-based processors. Although FIG. 1 shows the processor 112, the memory 114, and other components of the computing device 110 within the same block in terms of functionality, the processor 112 or the memory 114 actually may comprise multiple processors 112 and memories 114 that can be stored within the same physical casing or may not be stored within the same physical casing.

The computing device 110 may be any component typically used in conjunction with the computing device 110, for example, the aforementioned processor 112, memory 114, and an input device 120 (for example, a mouse, keyboard, touch screen, and/or microphone), and various electronic displays (for example, monitor with a screen or any other electronic equipment that are operable to display information). In several embodiments, the vehicle 100 comprises an in-car display 122 and one or multiple speakers 124 to provide information or audiovisual functions. In this respect, the in-car display 122 may be located inside the compartment of the vehicle 100 and used by the computing device 110 for delivering information to passengers inside the vehicle 100. In several embodiments, one or multiple computing devices 110 of the vehicle 100 also may, for example, receive information from or transmit information to other computing devices through a wireless port 126.

In several embodiments, the computing device 110 may be integrated into the autonomous computing system of the vehicle 100. For example, the computing device 110 may be connected with various system communication of the vehicle 100, for instance, a deceleration system 130 (for controlling vehicle brakes), an acceleration system 132 (for controlling vehicle acceleration), a steering system 134 (for controlling vehicle steering), a signal system 136 (for controlling the turn signals), a map system 138/indoor map system 139 (for navigating the vehicle 100 to a location or the vicinity of an object), a positioning system 140 (for confirming the location of the vehicle 100), a sensing system 142 (for detecting objects in the surrounding environment of the vehicle 100), and a power system 144 (for example, battery and/or gas engine or diesel engine), to maintain an autonomous driving mode according to the instruction 116 of the memory 114 without the involvement from passengers in the vehicle 100.

The computing device 110 may control the direction and speed of the vehicle 100 through the control of each component. For example, the computing device 110 may autonomously navigate the vehicle 100 completely to the pickup or drop-off location of the passenger by utilizing the data from the positioning system 140 and the map system 138, and respond to external objects when needed to arrive at the location safely. To achieve the aforementioned form of embodiments, the computing device 110 may accelerate (for example, by increasing the energy delivered to the power system 144 through the acceleration system 132), deaccelerate (for example, by reducing the energy delivered to the power system 144, changing the gear, and/or applying brakes through the deceleration system 130), change direction (for example, steering the front wheels or rear wheels of the vehicle 100 through the steering system 134), and issue signals of lane changes (for example, issuing the steering signal through the signal system 136) for the vehicle 100. Therefore, the acceleration system 132 and the deceleration system 130 may be a part of a power system 144 comprising a vehicle engine and various parts located between vehicle wheels. Likewise, by controlling these systems, the computing device 110 may also control the power system 144 of the vehicle 100 in order to control the vehicle autonomously.

In several embodiments, the computing device 110 may communicate with the deceleration system 130 and the acceleration system 132 to control the speed of the vehicle. In several embodiments, the computing device 110 may use the steering system 134 to control the direction of the vehicle 100. In several embodiments, the computing device 110 may use the signal system 136 to activate the turn signal, deliver a voice announcement, or display a text message to alert other road users before controlling the vehicle 100 to steer.

In several embodiments, the computing device 110 may use the map system 138 to confirm the route to reach the designated location. In several embodiments, the map system 138 comprises navigation functions, map information, and more. In several embodiments, the map system 138 and/or the data 118 may store map information, for example, high-precision maps that may be used by the computing device 110 for navigating or controlling the vehicle 100. In several embodiments, map information of the map system 138 comprises, but not limited to, parking lot entrance features, parking lot exit features, maps, driveway markings, stop signs, barrier curbs, sidewalks, roads, intersections, pedestrian crossings, speed limits, traffic signals, buildings, signs, real-time or historical traffic information, as well as shape and height information of vegetation or other objects of such types thereof. In several embodiments, the indoor map system 139 comprises, but is not limited to, real-time constructed environment maps, pre-constructed environment maps, point cloud planning maps, or a combination thereof.

In several embodiments, the computing device 110 may use a positioning system 140 to confirm the real-time location of the vehicle 100. In several embodiments, the positioning system 140 is divided into a first positioning system and a second positioning system, and the first positioning system is different from the second positioning system. The first positioning system serves as the positioning method when the computing device 110 controls the vehicle 100 while driving in an outdoor environment, wherein the first positioning system comprises, but is not limited to, the Global Positioning System (GPS), the BeiDou Navigation Satellite System (BDS), the Globalnaya Navigatsionnaya Sputnikovaya Sistema (GLONASS), the Galileo system, the Quasi-Zenith Satellite System (QZSS), the Indian Regional Navigation Satellite System (IRNSS), or a combination thereof. The second positioning system serves as the positioning method when the computing device 110 controls the vehicle 100 while driving in an indoor environment, wherein the second positioning system comprises, but is not limited to, an Assisted Global Positioning System (AGPS), visual image sensing, magnetic sensing technology, a radio-frequency identification based (RFID-based) indoor positioning system, or a combination thereof. An indoor space comprises a basement, an indoor space on the ground floor, an indoor space above the ground floor, or a combination thereof.

In several embodiments, the computing device 110 may use a sensing system 142 to detect conditions of the environment surrounding the vehicle 100 on a real-time basis. More specifically, the sensing system 142 identifies the traffic control status through cameras, light detection and ranging (LiDAR), radio detection and ranging (radar), magnetic sensing technology, or a combination thereof. For example, the entrance driveway traffic control status, which comprises the entrance driveway traffic light control, a single-lane driveway for two-way entrance and exit traffic, hand signals by the security guards, entrance driveway gates, or a combination thereof, will be identified.

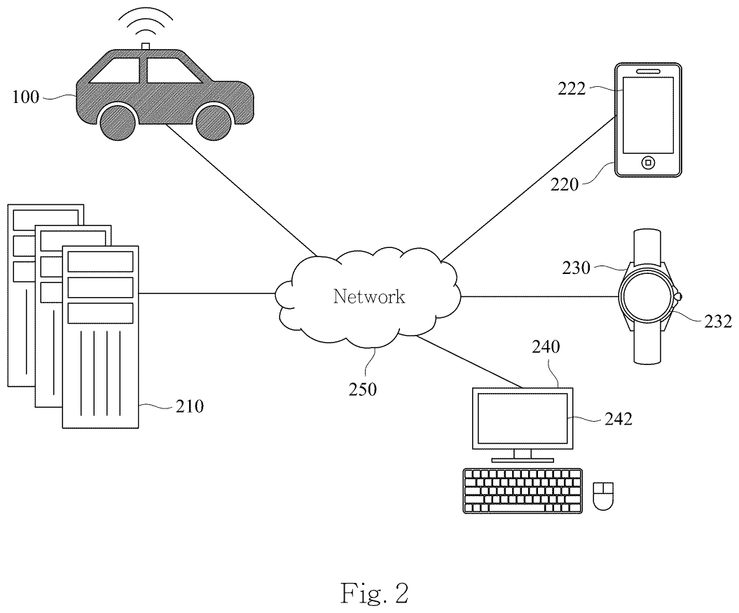

As shown in FIG. 2, each of the computing devices 210, 220, 230, 240 may comprise one or multiple processors, memory, data, and instructions. Such processors, memory, data, and instructions may be configured similarly to the one or multiple processors 112, memory 114, data 118, and instructions 116 of the computing device 110.

A network 250 and intermediate nodes may comprise various configurations and protocols, including short-range communication protocols, for example, Bluetooth, Internet, virtual private networks, wide area network, Ethernet, wireless network (WiFi) and hypertext transfer protocol (HTTP), radio-frequency identification (RFID), and networks of various combinations thereof. Such types of network communication methods can transmit or receive data through computing devices.

In several embodiments, the computing device 110 of the vehicle 100 may comprise multiple servers 210 connected externally, for example, load balancing server groups, which exchange information with different nodes of the network 250 to receive, process, and transfer the data, as well as information from other computing devices 110. For example, one or multiple servers 210 may be connected with the computing device 110 of the vehicle 100, a smartphone 220 of the user end, a smart wearable device 230, a computer 240 (for example, a laptop computer, tablet computer, or more) for communication, through the network 250. For example, the vehicle 100 may transmit location data of the vehicle 100 to the server 210 through the positioning system 140 regularly or irregularly so that the location of the vehicle 100 can be retrieved promptly. In several embodiments, the server 210 can be configured within the vehicle 100 directly.

In several other embodiments, the server 210 may use the network 250 to transfer and display messages, for example, messages that appear to users (for example, one or multiple users) on a display 222 of the smartphone 220, a display 232 of the smart wearable device 230, and a display 242 of the computer 240. In such an embodiment, the computing devices 220, 230, 240 may be regarded as the computing devices of the user end.

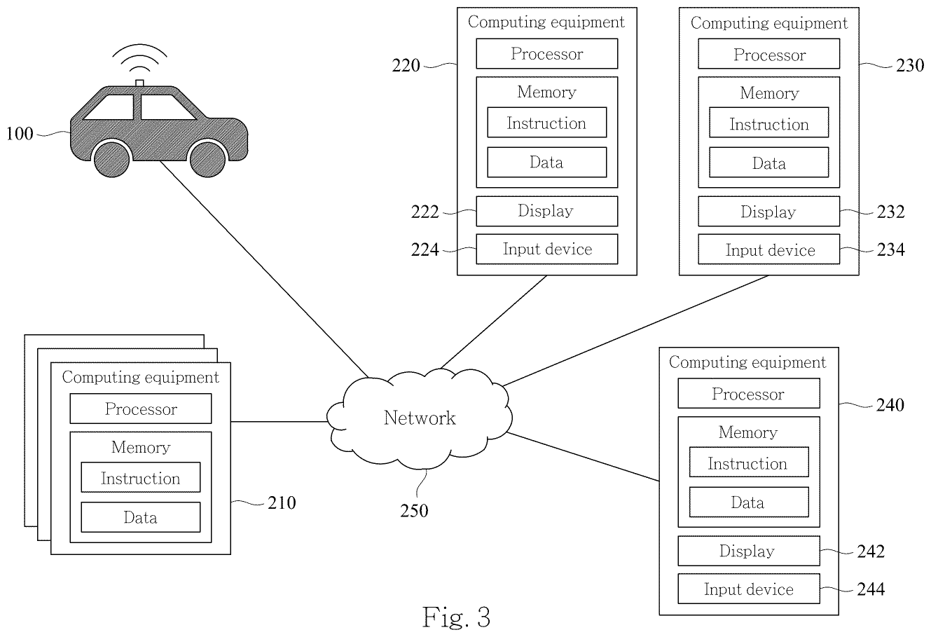

As shown in FIG. 3, multiple computing devices 220, 230, 240 of the user end may be provided as personal computing devices, allowing multiple users and having all components generally used in conjunction with personal computing devices. All components comprise one or multiple processors (for example, central processing units (CPU) and/or graphics processing units (GPU)), memory for storing data and instructions (for example, random access memory (RAM) and internal hard disks), displays 222, 232, 242 (for example, devices having mobile phone touch screens, touch screens of smart wearable devices, computer screens or other devices that are operable for displaying information), and multiple user input equipment 224, 234, 244 (for example, mice, keyboards, touch screens, function keys or microphones). For example, multiple users may use the input equipment 224, 234, and 244 of the computing devices 220, 230, 240 to send messages, for instance, requests to retrieve the vehicle 100 or get off the vehicle 100 to the server/computing device 210.

In several embodiments, all the computing devices 220, 230, and 240 of the user end may comprise various forms of personal computing devices. For example, the computing device 220 of the user end may be a smartphone; the computing device 230 of the user end may be a smart wearable device as shown in FIG. 2; the computing device 240 of the user end may be a computer, for example, a laptop computer or a tablet computer.

### Methods

In several embodiments, users may download the application programs for requesting the vehicle 100 to the computing devices 220, 230, 240 of the user end, which are then connected to one or multiple servers/computing devices 210. Next, the computing devices 220, 230, 240 of the user end may access the application programs and call for a vehicle. In several embodiments, users may send an instruction requesting a vehicle as well as sending the location information thereof for identifying the locations where the user intends to be picked up or dropped off, to one or multiple servers/computing devices 210, through the built-in positioning device (for example, GPS, AGPS) or map data (for example, Google maps, Apple maps, Baidu maps, Gaode maps) of the computing devices 220, 230, 240 of the user end.

In several embodiments, one or multiple servers/computing devices (for example, server/computing devices 210) will provide the vehicle 100 based on the vehicle availability for dispatch at the time and the user's proximity thereto, after receiving the instruction requesting a vehicle as well as the location information of the user sent by the computing devices 220, 230, 240 of the user end.

A method 300 for picking up or dropping off passengers indoors by an autonomous vehicle may be executed by one or multiple processors (for example, one or multiple processors 112 of the computing device 110) in the following embodiments.

In several embodiments, the method 300 for picking up or dropping off passengers indoors by an autonomous vehicle comprises the following steps:
(1) receiving, by at least a processor provided on the autonomous vehicle, a request for passengers to be picked up or dropped off at an indoor space of a building;
(2) confirming, by the at least one processor, using a map system and a first positioning system, an entrance position of the indoor space of the building;
(3) when the autonomous vehicle arrives at a location near the entrance position, confirming the entrance position by the at least one processor using at least one sensor, wherein the at least one sensor detects an entrance traffic control status of the entrance position to output an output signal;
(4) when the at least one processor receives the output signal and determines that the entrance traffic control status is an enterable state, controlling, by the at least one processor, the autonomous vehicle to drive into the indoor space from the entrance position;
(5) during the course of the autonomous vehicle entering the indoor space of the building, switching, by the at least one processor, to an indoor operation mode according to a switching signal, to control the autonomous vehicle to arrive at a passenger picking up position or dropping off position; and
(6) Establishing a departure path in the indoor operation mode according to a completion signal of the passenger pickup or drop-off from the autonomous vehicle, to control the autonomous vehicle leaving through an exit position of the indoor space of the building.

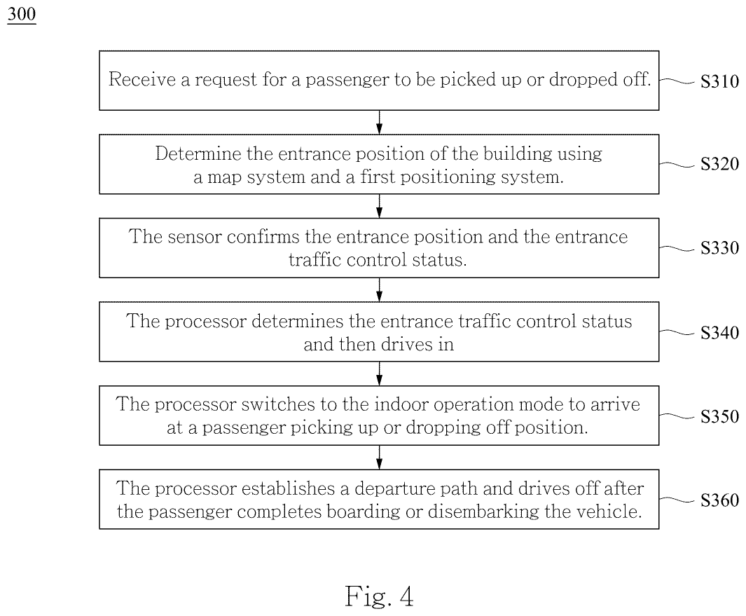

For the purpose of clear illustration of the operation of the method of the system for picking up or dropping off passengers indoor by an autonomous vehicle, the following detailed descriptions are provided along with FIG. 4. Please note that, the step orders mentioned in FIG. 4, unless otherwise specified in the order of the arrangement, may be adjusted, as well as executed all together simultaneously or partially executed simultaneously, and even may include additional steps or omit some steps, based on the actual need.

FIG. 4 is a flow chart of the method 300 for picking up or dropping off passengers indoors by an autonomous vehicle of several embodiments of the present disclosure, and please also refer to FIG. 1 to FIG. 3 at the same time. In the step S310 of receiving a request for picking up or dropping off a passenger, for example, at least a processor provided on the autonomous vehicle receives a request for a passenger to be picked up or dropped off at an indoor space of a building. In several embodiments, the passenger may be, for instance, a user located at an indoor space of a building, and the computing device of the user end (for example, the smartphone 220, the smart wearable device 230, or the computer 240) directly sends an instruction requesting a vehicle to the processor 112 of the vehicle 100 through the built-in positioning device or the map data. In several other embodiments, the passenger may be, for instance, a user located in an indoor space of a building, and the computing devices 220, 230, 240 of the user end send an instruction requesting a vehicle to one or multiple servers 210 through the built-in positioning device or the map data. Next, the server 210 communicates with all vehicles under its management, and deploys the vehicle 100 to carry out the task based on the vehicle availability for dispatch at the time and the user's proximity thereto. On the one hand, the server 210 transmits the user request to the vehicle 100 that can actually carry out the task, and on the other hand, the server 210 also provides relevant information about the vehicle 100 that can carry out the task to the user. In several embodiments, the indoor space comprises a basement, an indoor space on the ground floor, an indoor space above the ground floor, or a combination thereof. It should be understood that the location information received by the processor 112 or server 210 at the step S310 is the user's actual location. The location information is just a positioning coordinate without any extra details about the surroundings, like where the building entrance position is located.

In the step S320 of confirming the entrance position of the building through a map system and a positioning system, for example, at least a processor is used to confirm an entrance position of the indoor space of the building using a map system and a first positioning system. In several embodiments, the processor 112 of the vehicle 100 confirms an entrance position of the indoor space of the building using a map system 138 and a first positioning system 140. In several embodiments, the map system 138 comprises parking lot entrance features, parking lot exit features, maps, driveway markings, stop signs, barrier curbs, sidewalks, or a combination thereof. In an embodiment, the positioning system 140 is the first positioning system suited to functioning in an outdoor environment. As a supplementary note, in the step S320, since the autonomous vehicle has not yet arrived at the site, the processor 112 of the vehicle 100 merely uses existing map information in the map system 138 to locate and confirm the possible entrance position to the building where the user is located.

In the step S330, the sensor confirms the entrance position and the entrance traffic control status. For example, when the autonomous vehicle arrives at a location near the entrance position, at least one processor uses at least one sensor to confirm the entrance position, wherein at least one sensor detects an entrance traffic control status of the entrance position to output an output signal. In several embodiments, if the processor 112 of the vehicle 100 determines, using the sensing system 142, that the arriving position of the vehicle 100 in fact is not the actual entrance position of the building, for example, the entrance and exit of the building may be located in different parts of the building, or the user's actual location may be relatively closer to the entrance of another building that is not the target building, it means that the original supplementary information (for example, building features, etc.) of the map system 138 contains errors or is not updated to the latest information. In response, the vehicle 100 will proceed to perform cruising searches according to the map system 138 and the positioning system 140 again along the road in the area where the building is located to find the correct entrance position of the building. Specifically, the processor 112 of the vehicle 100 may use the sensing system 142 (for example, a camera) to perform real-time image analysis on the target building to identify markings or signs (text or graphs) containing entrance-related information, and then to confirm the correct entrance position of the building. Furthermore, when the processor 112 of the vehicle 100 confirms the correct entrance position of the building, the map system 138 is updated immediately.

In several embodiments, the sensing system 142 of the vehicle 100 detects the real-time conditions and the traffic control status of the entrance position. For example, when the vehicle 100 arrives at a location near the entrance position, the sensing system 142 identifies various conditions of control signals, markings, movements, and actions, for instance, traffic lights, two-way entrance and exit driveways, hand signals by the security guard, gates/fences, and height restrictions. In several embodiments, after the sensing system 142 of the vehicle 100 detects the real-time conditions and the traffic control status of the entrance position, the sensing system outputs the output signal instruction to the processor 112 of the vehicle 100. In several embodiments, besides the sensing system 142 of the vehicle 100 detecting the real-time conditions and the traffic control status of the entrance position, the embodiments may also comprise confirming the entrance position and the traffic control status accessed by at least one surveillance camera through the network 250 with the processor 112.

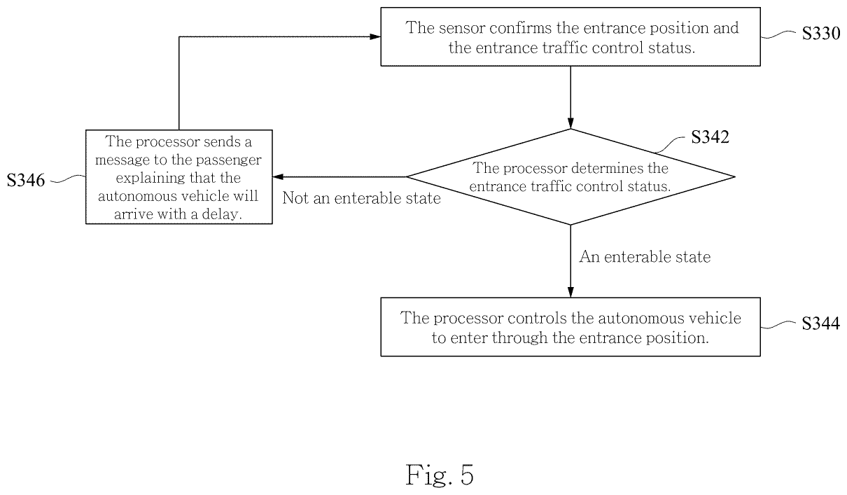

In the step S340, the vehicle 100 drives into the building after the processor 112 determines the entrance traffic control status. For example, when the at least one processor 112 receives the output signal and determines that the entrance traffic control status is an enterable state, at least one processor 112 controls the autonomous vehicle 100 to drive into the indoor space from the entrance position. Meanwhile, please refer to FIG. 5, as in several embodiments, in the step S342, the processor determines the entrance traffic control status. For example, when the processor 112 of the vehicle 100 receives information of the entrance position and the entrance traffic control status detected by the sensing system 142, the processor 112 determines whether the vehicle 100 may enter the indoor of the building through the entrance position under the condition at the time.

If the entrance traffic control status is an enterable state, in the step S344, the processor 112 controls the autonomous vehicle 100 to drive into the building through the entrance position. For example, when confirming an enterable state, the processor 112 of the vehicle 100 controls the acceleration system 132 and the power system 144 to output the power, together with the steering system 134, for making the vehicle 100 turn when needed, and at the same time enables the signal system 136 to flash the turn signal for alert.

If the entrance traffic control status is not an enterable state, in the step S346, the processor 112 transmits messages to the personnel explaining that the autonomous vehicle 100 will arrive with a delay. For example, when confirming a non-enterable state, the vehicle 100 will temporarily stop at a proper position (for example, close to the edge of the road) in front of the entrance position, and the processor 112 of the vehicle 100 will transmit messages to the computing device (for example, the smartphone 220, the smart wearable device 230, or the computer 240) of the user end, and display massages explaining that the vehicle 100 will arrive at the pickup or drop-off location with delay and relevant information of the cause or reasons (for example, current traffic control condition at the entrance position) on the displays 222, 232, or 242. Next, back to the step S330, the sensing system 142 of the vehicle 100 will continuously detect the real-time scenarios and the traffic control status of the entrance position. In several embodiments, when encountering a non-enterable state, the processor 112 of the vehicle 100 not only transmits messages to the user, but also notifies the user with a message indicating that a change of pickup/drop-off position can be accepted, for example, the processor 112 of the vehicle 100 may identify a suitable (outdoor) parking location in the vicinity of the entrance position that does not affect other drivers and pedestrians, and inquire whether the user wants to be picked up at the provided suitable location. Meanwhile, the vehicle 100 may also further accept another pickup position designated by the user.

In the step S350, the processor 112 switches to an indoor operation mode to arrive at a passenger pickup or drop-off position. For example, during the course of the autonomous vehicle 100 entering the indoor space of the building, the operation is switched by the at least one processor 112 to the indoor operation mode according to a switching signal, to control the autonomous vehicle to arrive at a passenger pickup or drop-off position.

In several embodiments, when the first positioning system of the positioning system 140 of the vehicle 100 loses signals, or when the maps of the map system 138 encounter a switching point, or when insufficient maps are in the map system 138, or a combination thereof, the positioning system 140 and/or the map system 138 trigger a switching signal to be sent to the processor 112 of the vehicle 100. Next, after the processor 112 of the vehicle 100 receives the switching signal, the vehicle 100 is switched to the indoor operation mode. More specifically, the indoor operation mode is to control the vehicle 100 to drive indoors using an indoor map system 139 in conjunction with the second positioning system. In several embodiments, the indoor map system 139 comprises real-time constructed environment maps, pre-constructed environment maps, point cloud planning maps, or a combination thereof. In several embodiments, the second positioning system comprises the Assisted Global Positioning System (AGPS), visual image sensing, magnetic sensing technology, an RFID-based indoor positioning system, or a combination thereof.

In several other embodiments, the processor 112 of the vehicle 100 sends an instruction for switching to an indoor operation mode to the sensing system 142, and the sensing system 142 (for example, cameras, LiDAR, radar) constructs the environment maps on a real-time basis to navigate the vehicle 100 driving indoors.

In several other embodiments, the processor 112 of the vehicle 100 sends an instruction for switching to an indoor operation mode to the map system 138, and the map system 138, based on the pre-constructed indoor environment maps in conjunction with the sensing system 142 (for example, cameras, LiDAR, radar), navigates the vehicle 100 driving indoors.

In several other embodiments, the processor 112 of the vehicle 100 sends an instruction for switching to an indoor operation mode to the sensing system 142, and the sensing system 142 guides the vehicle 100 to drive indoors with the magnetic sensing technology through sensing the indoor driveway markings or the magnet materials buried around the driveways. In several other embodiments, the processor 112 of the vehicle 100 sends an instruction for switching to the indoor operation mode to the sensing system 142, and the sensing system 142 then guides the vehicle 100 to drive indoors by sensing the indoor driveway markings or the radio-frequency identification (RFID) equipment installed around the driveways.

In several embodiments, the pickup or drop-off position for passengers in the indoor space of the building may be a specifically designated area, for example, an area with special line markings, number markings, electronic components for identification, etc., that help the vehicle 100 to easily identify therewith while driving indoors.

In the step S360, after the passenger boards or disembarks the vehicle 100, the processor 112 establishes a departure path, and the vehicle 100 exits. For example, the processor 112 establishes a departure path in the indoor operation mode according to a completion signal of the passenger boarding or disembarking the vehicle 100, to then control the autonomous vehicle 100 to drive through the exit position from the indoor space of the building. In several embodiments, after the user gets on the vehicle 100, the processor 112 of the vehicle 100 may control the in-car display 122 or the speaker 124 to instruct the user to confirm whether the boarding process is completed, and receive a signal of boarding completion through the user's operation on the input device 120. In several embodiments, after the passenger completes disembarking the vehicle 100, whenever the wireless port 126 of the vehicle 100 does not detect the computing devices 220, 230, 240 of the user end, it will be determined that the user has disembarked the vehicle 100 and has transmitted a disembarkation completion signal to the processor 112 of the vehicle 100. Next, the vehicle 100 establishes a departure path in the indoor operation mode, wherein the establishing method thereof is similar to that of the step S350, which uses an indoor map (for example, real-time environment maps, pre-constructed environment maps, point cloud planning maps, or a combination thereof) together with a second positioning system, to control the vehicle 100 to drive off from the exit position of the indoor space of the building. In several embodiments, the step prior to the autonomous vehicle driving off from the exit position is similar to that in the step S330, which uses the sensor to confirm the exit position and the exit traffic control status, and therefore, will not be repeatedly described here again.

In several embodiments, when the vehicle 100 drive off from the exit position of the building and the first positioning system of the positioning system 140 regains the signal, or when the maps of the indoor map system 139 encounter a pre-set switching point, or when there is insufficient maps in the indoor map system 139, or a combination thereof, the processor 112 of the vehicle 100 is forced to switch from the indoor operation mode back to a normal operation mode. In other words, the map system 138 and the first positioning system of the positioning system 140 are utilized again while the vehicle 100 is driving on the outdoor roads.

The above preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure and shall be included in the appended claims. Thus, the scope of protection of the present disclosure shall be determined by the appended scope of the claims.

### COMPONENT SYMBOL

100: Vehicle
110: Computing device
112: Processor
114: Memory
116: Instruction
118: Data
120: Input device
122: In-car display
124: Speaker
126: Wireless port
130: Deceleration system
132: Acceleration system
134: Steering system
136: Signal system
138: Map system
139: Indoor map system
140: Positioning system
142: Sensing system
144: Power system
210: Computing device/server
220: Computing device/smartphone
222: Display
224: Input equipment
230: Computing device/smart wearable device
232: Display
234: Input equipment
240: Computing device/computer
242: Display
244: Input equipment
250: Network
300: Method
S310, S320, S330, S340, S342, S344, S346, S350, S360: Step

What is claimed is:

1. A method for picking up or dropping off passengers indoors by an autonomous vehicle, the method comprising:
(1) receiving, by at least one processor provided on the autonomous vehicle, a request for a passenger to be picked up or dropped off at an indoor space of a building;
(2) confirming, by the at least one processor, using a map system and a first positioning system, an entrance position of the indoor space of the building;
(3) when the autonomous vehicle arrives at a location near the entrance position, confirming the entrance position by the at least one processor using at least one sensor, wherein the at least one sensor detects an entrance traffic control status of the entrance position to output an output signal;
(4) when the at least one processor receives the output signal and determines that the entrance traffic control status is an enterable state, controlling, by the at least one processor, the autonomous vehicle to drive into the indoor space from the entrance position;
(5) during a course of the autonomous vehicle entering the indoor space of the building, switching, by the at least one processor, to an indoor operation mode according to a switching signal, to control the autonomous vehicle to arrive at a passenger picking up or dropping off position; and
(6) establishing, by the at least one processor, a departure path in the indoor operation mode according to a completion signal of the passenger pickup or drop-off from the autonomous vehicle, to control the autonomous vehicle leaving through an exit position of the indoor space of the building.

2. The method of claim 1, wherein the indoor space comprises a basement, an indoor space on a ground floor, an indoor space above the ground floor, or a combination thereof.

3. The method of claim 1, wherein the map system comprises parking lot entrance features, parking lot exit features, maps, driveway markings, parking markings, barrier curbs, sidewalks, or a combination thereof.

4. The method of claim 1, wherein the first positioning system comprises a Global Positioning System, a BeiDou Navigation Satellite System, a GLONASS system, a Galileo positioning system, a Quasi-Zenith Satellite System, an Indian Regional Navigation Satellite System, or a combination thereof.

5. The method of claim 1, wherein the step (3) comprises confirming the entrance position accessed by at least one surveillance camera through a network with the at least one processor.

6. The method of claim 1, wherein the entrance traffic control status comprises an entrance driveway traffic light control, a single-lane driveway for two-way traffic at an entrance, hand signals by a security guard, entrance driveway gates, or a combination thereof.

7. The method of claim 1, wherein, prior to the step (4), the method further comprises:
sending, by the at least one processor, a message to the passenger with corresponding information indicating that the autonomous vehicle will arrive at the passenger picking up or dropping off position with delay when the at least one processor receives the output signal and determines that the entrance traffic control status is not the enterable state, or
notifying the passenger that an instruction of a changed picking up or dropping off position can be accepted, based on the entrance traffic control status when the at least one processor receives the output signal and determines that the entrance traffic control status is not the enterable state.

8. The method of claim 1, wherein the switching signal comprises signal disappearance of the first positioning system, maps of the map system encountering a switching point, insufficient maps in the map system, or a combination thereof.

9. The method of claim 1, wherein the at least one processor uses an indoor map together with a second positioning system in the indoor operation mode to enable the autonomous vehicle to drive in the indoor space, wherein the indoor map comprises real-time environment maps, pre-constructed environment maps, point cloud planning maps, or a combination thereof.

10. The method of claim 9, wherein the second positioning system comprises at least one of an Assisted Global Positioning System, visual image sensing, magnetic sensing technology, or a radio-frequency identification based (RFID-based) indoor positioning system.
